(19) United States
(12) Patent Application Publication
(10) Pub. No.: US 2017/0113159 A1
(43) Pub. Date: Apr. 27, 2017

(54) Rotary Evaporator

(71) Applicant: HANS HEIDOLPH GMBH & CO. KG, Kelheim (DE)

(72) Inventors: Joachim Carl, Stein (DE); Walter Lohmann, Wendelstein (DE)

(73) Assignee: HANS HEIDOLPH GMBH & CO. KG, Kelheim (DE)

(21) Appl. No.: 15/309,312

(22) PCT Filed: Apr. 29, 2015
(86) PCT No.: PCT/EP2015/059344

§ 371 Date: Jan. 10, 2017

(30) Foreign Application Priority Data
May 7, 2014 (DE) 10 2014 106 406.2

(51) Int. Cl. B01D 3/08

(52) U.S. Cl. CPC B01D 3/085

(57) ABSTRACT

A rotary evaporator comprises a device (10) for securing a ground connection, comprising a ground sleeve and a ground core, between an evaporator piston and a vapor leadthrough. The securing device has a receiving opening (17) for that end of the evaporator piston provided with the ground sleeve, and a securing element (13) which can be moved between a retaining position and a release position and which has a retaining section (31) that, in the retaining position, projects into the receiving opening (17) and that, in the release position, is at least partially retracted from the receiving opening (17), so as to secure or release, as desired, that end of the evaporator piston provided with the ground sleeve.

The present application relates to a rotary evaporator having an apparatus for the securing of a ground joint comprising a ground socket and a ground cone between an evaporator flask and a vapor leadthrough.

A rotary evaporator is a laboratory apparatus which typically comprises a heating bath and an evaporator flask which can dip into the heating bath. In operation, a liquid medium present in the heating bath, for example water or—for higher temperatures—oil, is heated in order thus to heat the evaporator flask dipped into the heating bath. A mixture, in particular a liquid mixture, contained in the evaporator flask can hereby be heated so that the respective distillate, in particular solvent, is evaporated. The evaporated distillate then flows into a cooler of the rotary evaporate to condense there. The condensate is subsequently collected in a collection flask. The distillation residue remaining in the evaporator flask can be further processed or analyzed. A vacuum pump is frequently additionally provided for the generation of a vacuum in the evaporator flask and in the cooler to lower the boiling point, whereby the distillation can be accelerated and the distillation rate can be increased. A heating bath is, however, not absolutely necessary. An evaporation can, for example, also be effected solely by generating a vacuum. A heating dish, a heating mantle or a heating quiver can e.g. also be used instead of a heating bath.

A rotary evaporator furthermore comprises a rotary drive for the rotation of the evaporator flask in the heating bath or in the respective heating medium. The evaporator flask is uniformly heated due to the rotation and a thin liquid film is produced at the heated inner wall of the evaporator flask which has a large surface and from which the distillate can be evaporated fast, efficiently and gently.

In order to set into rotation the evaporator flask which is rotationally fixedly connected to the initially named vapor leadthrough via a ground glass joint, the vapor leadthrough, which is usually formed as a hollow glass shaft and which serves to conduct the evaporated distillate from the evaporator flask to the cooler, is rotatingly driven by the rotary drive. Keck clips can be used to secure ground glass joints.

Keck clips, however, have to be adapted to the respective currently used taper of the ground glass joint. This means that a plurality of different clips have to be provided if a use of the rotary evaporator with different tapers or standard tapers is considered. In addition, glass components that are provided with a ground cone or a ground socket have manufacturing tolerances that are considerable in some cases. Such tolerances can only be compensated to a limited extent on the use of Keck clips as securing apparatus.

It is an object of the invention to provide a rotary evaporator of the initially named kind that can ensure a reliable securing of a ground joint, in particular in which the evaporator flask can be secured to the vapor leadthrough in a simple manner independently of the taper of the ground joint used.

The object is satisfied by a rotary evaporator having the features of claim 1.

In accordance with the invention, the securing apparatus has a receiver opening for the end of the evaporator flask provided with the ground socket and a securing element that is adjustable between a holding position and a release position, that has a holding section that projects into the receiver opening in the holding position and that is at least partly retracted from the receiver opening in the release position to selectively hold or release the end of the evaporator flask provided with the ground socket.

When the securing element is in the release position, the end of the evaporator flask provided with the ground socket can be introduced into the receiver opening of the securing apparatus until the ground socket has been placed onto the ground cone in the desired manner and has been rotationally fixedly connected thereto. The securing element can subsequently be moved into the holding position, with it moving into contact with the end of the evaporator flask. The securing element holds the evaporator flask in this position. in a clamping and/or shape-matched manner at the vapor leadthrough—in particular by engaging behind a flanged rim formed at the flask end. The securing element can in particular project at different lengths into the receiver opening so that the use of the securing apparatus is not restricted to a specific taper. In addition, the reliability of the securing is not impaired by tolerances of the evaporator flask or of the vapor leadthrough in the region of the ground socket and of the ground cone. The invention further makes possible a simple and intuitive operation of the rotary evaporator.

The securing element can be supported in a plane extending transversely, in particular substantially perpendicular, to an introduction direction of the ground socket and/or continuously displaceably, in particular linearly displaceably. I.e. the securing element moves laterally toward or away from the end of the evaporator flask. A problem-free engaging behind a flanged rim or any other flange formed at the flask end by the securing element is thus possible, for example. Alternatively and/or additionally, the securing element can also be supported such that it is pivotable in the aforesaid plane.

The securing element is preferably preloaded in the direction of the holding position to avoid an unintended release of the securing. The preload can in this respect simply be provided by one or more spring elements.

In accordance with an embodiment of the invention, the securing element has a run-on ramp that is in particular inclined into the receiver opening against an introduction direction of the evaporator flask provided with the ground socket and that cooperates with the end of the evaporator flask provided with the ground socket on the latter's introduction into the receiver opening to press the securing element out of its holding position into the release position. To provide such a run-on ramp, it is sufficient if at least the holding section of the securing element is provided with a sloping surface or chamfer or the like. Due to the run-on ramp it is not absolutely necessary that a user manually moves the securing element into the release position before the introduction of the flask end into the receiver opening to fasten the evaporator flask to the vapor leadthrough; the securing element is rather automatically adjusted into the release position by the end of the evaporator flask provided with the ground socket on the introduction such that the operation of the rotary evaporator is substantially simplified.

A further embodiment of the invention provides that the securing apparatus comprises an actuation element such as a push button by means of which the securing element can be adjusted from the holding position into the release position, in particular also in the case that the end of the evaporator flask provided with the ground socket is received in the receiver opening. This facilitates a release of the securing for a user in order, for example, to be able to carry out a flask change.

The actuation element can be formed in one part with the securing element. A push button can, for example, be molded directly to a linearly displaceable securing element such that a displacement movement of the securing element is triggered by an actuation of the push button. Such a single-part embodiment saves manufacturing costs and construction space. The actuation element can generally also be formed separately from the securing element and can pressurize it directly or indirectly on actuation.

A further embodiment of the invention provides that the securing element is formed as a slider plate, in particular having a passage opening for the end of the evaporator flask provided with the ground socket. This allows a particularly simple design.

The axes of the receiver opening and of the passage opening can in particular be offset in parallel with one another in the holding position and/or can extend coaxially with one another in the release position. A parallel offset of the passage opening with respect to the receiver opening effects a reduction of the free passage surface that is present overall and that can be used for holding the introduced flask end. The change between the release position and the holding position is particularly simple in this respect.

The holding section can be formed by a part of the opening margin of the securing element bounding the passage opening. A complex and/or expensive separate holding section can thus be dispensed with.

A respective spring element can be provided at at least one narrow side of the securing element, in particular at mutually opposite narrow sides, to preload the securing element in the direction of the holding position. In this respect, the respective spring element can, on the one hand, be supported at a respective outwardly projecting abutment formed at the respective narrow side and can, on the other hand, be supported at a respective counter bearing provided in the securing apparatus. A preload at both sides inter alia prevents an unwanted canting of the securing element in an associated guide.

The securing element can be supported by means of a slide support in the securing apparatus. In this respect, slide projections can be provided at at least one flat side of the securing element. A slide support allows a particularly simple and inexpensive manufacture. The securing element could generally, however, also e.g. be supported by means of a roller-element support in the securing apparatus, as required. Slide projections at one flat side or at both flat sides of the securing element reduce the effect of friction and thus allow a simpler actuation. The slide projections can in particular be of runner-like design.

The holding section can have a recess, in particular of the shape of an arc of a circle, in its region cooperating with the end of the evaporator flask provided with the ground socket. The recess can partly engage around the flask end and can thus reinforce the securing effect. The recess preferably has a contour having a curvature that corresponds to an outer curvature of the end of an evaporator flask provided with a ground socket.

A further embodiment of the invention provides that the holding section is provided with a fixed-shape, elastically deformable plastic in its region cooperating with the end of the evaporator flask provided with the ground socket. An elastomer element can, for example, extend along the extent of the holding section. Alternatively, a plurality of elastomer elements can be arranged along the extent of the holding section and/or can be arranged distributed spaced apart from one another at the holding section. The elastically deformable plastic, for example silicone, provides a particularly reliable hold of the evaporator flask.

The securing apparatus can comprise a fastening section that is fastened at one end to a rotary drive of the rotary evaporator and whose other end is provided with the receiver opening. When the securing element holds the flask end in the receiver opening, the evaporator flask is thus in total fixed to the rotary drive of the rotary evaporator. The evaporator flask can thus not drop off.

The one end of the fastening section can be provided with a thread, in particular with an internal thread, by means of which the fastening section is screwed onto a counter-thread, in particular an external thread, formed at the rotary drive. This allows a simple attachment of the fastening section to the rotary drive and, if required, a simple replacement of the securing apparatus.

An annular cover is preferably fastened, in particular by pinned fastening or screwing, to the other end of the fastening section and the receiver opening extends through it. The pinned fastening or screw connection can be released as required, e.g. to replace the securing element.

In accordance with a further embodiment of the invention, the securing element is arranged, in particular captured, in a sliding seat in particular formed between the aforesaid fastening section and the aforesaid annular cover. This allows a particularly simple design. The securing element is in particular supported, in particular slidingly guided, in the sliding seat.

The securing element can furthermore have at least one elongate hole through which a respective fastening means is led for fastening the cover to the fastening section. The elongate hole allows an adjustment movement of the securing element without hindrance from the fastening means.

The cover can have at least one counter bearing for a respective spring element to preload the securing element in the direction of the holding position. The spring element can be supported at the counter bearing and can thus provide a reliable preloading effect.

The invention further relates to an apparatus for securing a ground joint comprising a ground socket and a ground cone between an evaporator flask and a vapor leadthrough, with the securing apparatus having a receiver opening for the end of the evaporator flask provided with the ground socket and a securing element adjustable between a holding position and a release position, the securing element having a holding element that projects into the receiver opening in the holding position and that is at least partly retracted from the receiver opening in the release position to selectively hold or release the end of the evaporator flask provided with the ground socket.

Advantageous embodiments of the securing apparatus in accordance with the invention result in an analog manner from the embodiments described above with respect to the rotary evaporator in accordance with the invention.

Further developments of the invention are also set forth in the dependent claims, in the description and in the enclosed drawings.

The invention will be described in the following by way of example with reference to the drawings.

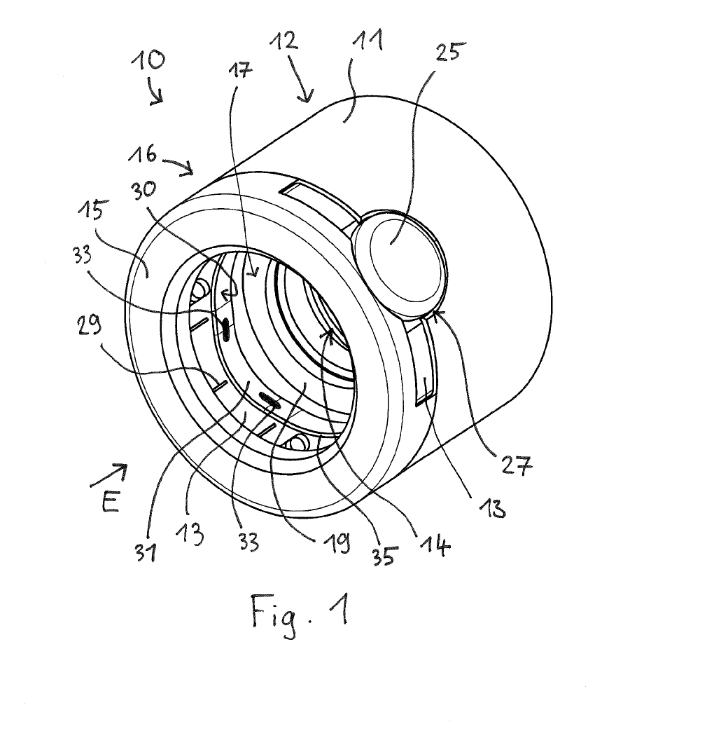

FIG. 1 is a perspective representation of a securing apparatus of a rotary adapter in accordance with the invention;

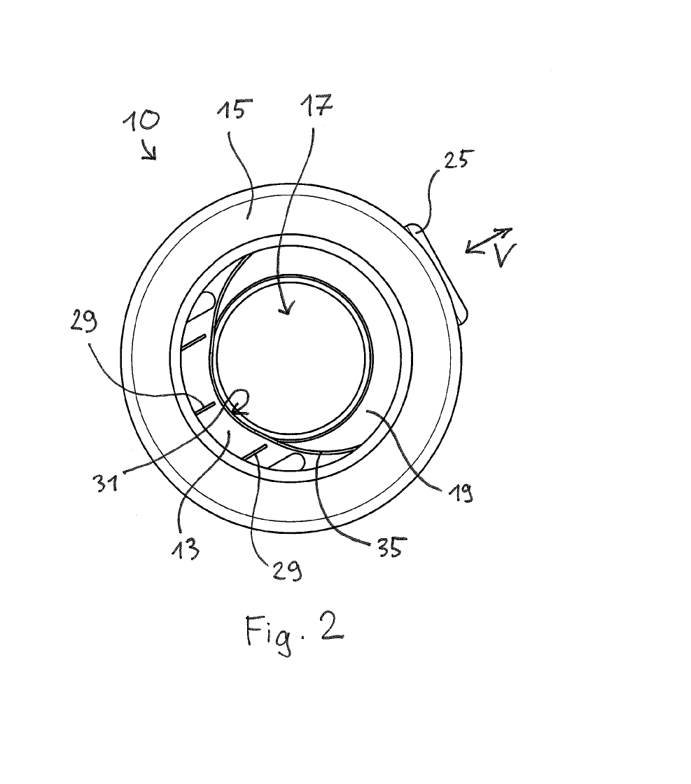

FIG. 2 shows the securing apparatus in accordance with FIG. 1 in a front view;

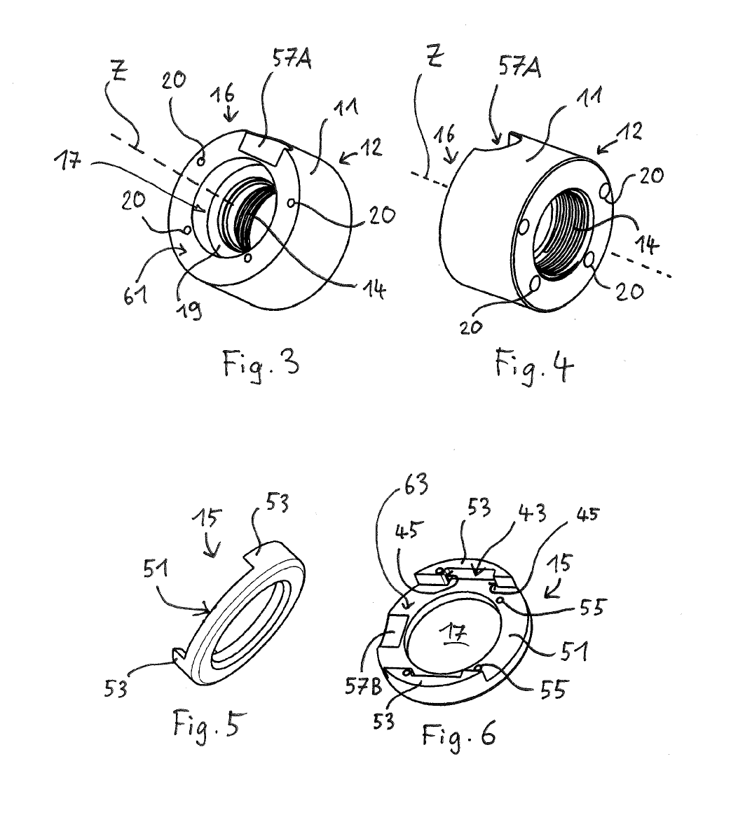

FIG. 3 is a perspective representation of a fastening section of the securing apparatus shown in FIG. 1 in a view obliquely from the front;

FIG. 4 shows the fastening section in accordance with FIG. 3 in a view obliquely from the rear;

FIG. 5 is a perspective representation of a cover for the fastening section shown in FIG. 3 in a view obliquely from the front;

FIG. 6 shows the cover in accordance with FIG. 5 in a view obliquely from the rear;

FIG. 7 is a plan view of a securing element of the securing apparatus shown in FIG. 1; and

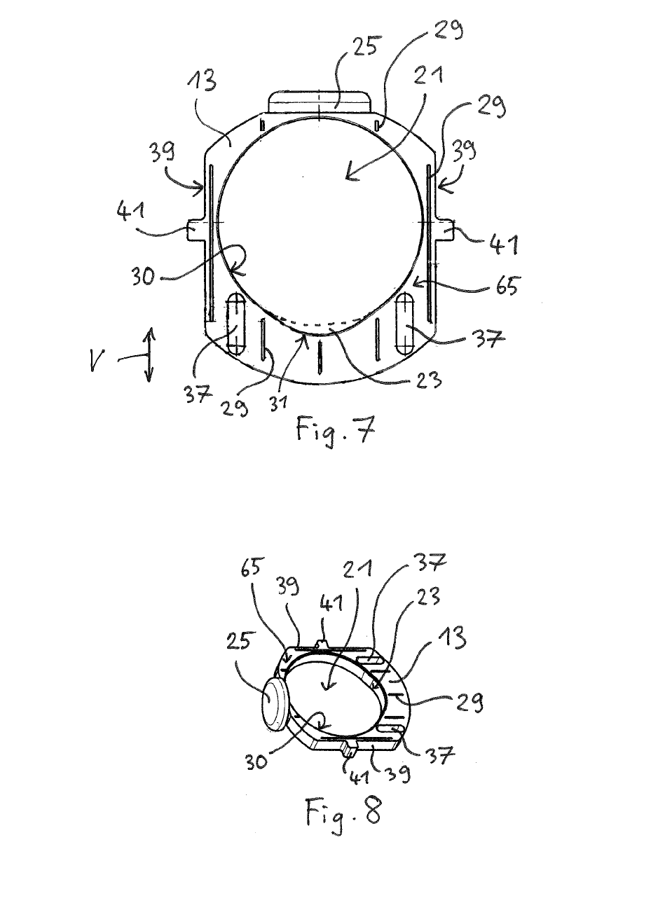

FIG. 8 is a perspective representation of the securing element in accordance with FIG. 7.

The securing apparatus 10 shown in FIGS. 1 and 2 for a ground glass joint between a ground socket of an evaporator flask and a ground cone of a vapor leadthrough is associated with a rotary evaporator, not shown. The securing apparatus 10 is substantially composed of a hollow cylindrical fastening section 11, an annular cover 15 and a securing element in the form of a slider plate 13 arranged between the fastening section 11 and the annular cover 15.

The fastening section 11 of the securing apparatus 10 shown in a respective single representation in FIGS. 3 and 4 has an internal thread 14 at the end 12 at the rear in FIGS. 1 and 3 by means of which the securing apparatus 10 can be screwed (not shown) onto an external thread formed at a hub of a rotary drive of the rotary evaporator. The securing apparatus 10 is hereby held at the rotary drive.

The annular cover 15 shown in a respective single representation in FIGS. 5 and 6 has a central circular opening and is fastened to the end 16 of the fastening section 11 at the front in FIGS. 1 and 3. A receiver opening 17 is formed at this end and continues through the circular opening of the cover 15 and into which an end of an evaporator flask, not shown, provided with a ground socket can be introduced in an introduction direction E. A front annular surface 19 formed at an inner wall of the fastening section 11 can in this respect form an abutment for the introduced end of the evaporator flask.

If the fastening section 11 is screwed to the hub of the rotary drive of the rotary evaporator, the ground cone of the vapor leadthrough rotationally fixedly received in the hub of the rotary drive projects into the fastening section 11 such that the ground socket of an end of a rotary flask led sufficiently far through the receiver opening 17 moves into a sealing and holding engagement with the ground cone of the vapor leadthrough. In the operation of the rotary drive, the hub of the rotary drive, the securing apparatus 10, the vapor leadthrough and the evaporator flask rotate about their common longitudinal axis and distillate evaporated from the evaporator flask can be supplied to a cooler via the vapor leadthrough.

As can be seen from FIGS. 3 and 4, four passage holes 20 extend through the fastening section 11 in parallel with a cylinder axis Z. Four blind holes 55, in particular each having a thread, are correspondingly formed at the rear side 63 of the cover 15 and are aligned with the passage holes 20 of the fastening section 11 in the assembled state of the securing apparatus 10 so that the cover 15 can be fastened to the fastening section 11 by screws or pins inserted into the respective holes 20, 55.

The slider plate 13 respectively shown in an individual representation in FIGS. 7 and 8 has a central passage opening 21 through which the end of the evaporator flask provided with the ground socket can be led through on the introduction into the receiver opening 17. The slider plate 13 is linearly displaceably captured in a displacement direction V between the fastening section 11 and the annular cover 15 in a sliding seat between a holding position shown in FIGS. 1 and 2 and a release position, not shown, to either hold (holding position) or release (release position) the end of the evaporator flask provided with the ground socket.

The passage opening 21 has a substantially circular cross-section with a diameter at least substantially identical to the receiver opening 17 of the securing apparatus 10. Differing from an exactly circular cross-section, the passage opening 21, however, additionally has a recess 23 of the shape of an arc of a circle that is emphasized by a dashed line in FIG. 7 and whose function is explained in more detail in the following. Two elongate holes 37 through which the aforesaid screws or pins, which serve for the fastening of the cover 15 to the fastening section 11, are led in the assembled state of the securing apparatus 10 furthermore run through the slider plate 13.

The slider plate 13 is continuously displaceably arranged in an elongate guide recess 51 formed at the rear side of the cover 15 that extends between two guide walls 53 of the cover 15 opposite one another with respect to the displacement direction V. Respective hollows 43 that are bounded by respective necks 45 in the displacement direction V are formed in the guide walls 53 of the cover 15. Furthermore, respective radially outwardly projecting abutments 41 are provided at mutually opposite narrow sides 39 of the slider plate 13 and project into the hollows 43 of the cover 15 in the assembled state of the securing apparatus 10 such that the slider plate 13 is captively held between the fastening section 11 and the cover 15.

The slider plate 13 is slidingly displaceably guided in the displacement direction V extending transversely, in particular perpendicular, to the introduction direction E of the end of the evaporator flask provided with the ground socket through a front end face 61 of the fastening section 11, the rear side 63 of the cover 15 and the guide walls 53. To enable a low-friction sliding of the slider plate 13, a plurality of mutually parallel runners 29 are arranged at both flat sides 65 of the slider plate 13.

A respective compression spring, not shown, is provided between the necks 45 and the abutments 41 at both narrow sides 39 of the slider plate 13. The respective compression spring is in this respect supported at a respective neck 45 of the respective hollow 43 of the cover 15 and the respective abutment 41 of the slider plate 13 such that the slider plate 13 is preloaded in the direction of the holding position. This in particular means that the slider plate 13 is also located in the holding position when no evaporator flask has been inserted into the receiver opening 21.

In the holding position of the slider plate 13 correspondingly shown in FIGS. 1 and 2, the centers of the receiver opening 17 and of the passage opening 21 are offset from one another so that a part of the slider plate 13 projects into the receiver opening 17. In this position, the part of the opening margin 30 of the passage opening 21 that is disposed in the region of the recess 23 forms a holding section 31 that projects into the receiver opening 17 and that can hold an end of an evaporator flask located in the fastening section 11 with a force fit and/or with shape matching. The recess 23 in this respect has a radius that corresponds to the relevant radius of the end of the evaporator flask provided with the ground socket, whereby the reliability of the holder of the evaporator flask can be increased. Furthermore, elastomer elements or elastomer inserts 33 (FIG. 1) are provided in the region of the holding section 31 to further increase the reliability of the holder of the evaporator flask.

An integral push button 25 is provided at an end of the slider plate 13 remote from the recess 23 and is received in the assembled state of the securing apparatus 10 in a cut-out 27 (FIG. 1) that is formed by two complementary semi-round cut-outs 57A, 57B that are formed in the region of the front end of the fastening section 11 or at the rear side of the cover 15. The slider plate 13 can be displaced along the displacement direction V into the release position against the preload of the compression springs by an actuation of the push button 25, with the receiver opening 17 and the passage opening 21 being arranged concentrically with respect to one another in said release position. In this release position, the passage opening 21 of the slider plate 13 completely releases the receiver opening 17 such that an evaporator flask received in the receiver opening 17 can again be removed therefrom. Depending on the diameter of the flange rim or of any other flange formed at the end of the evaporator flask provided with the ground socket, the release position can also already be reached when the holding section 31 has not been completely retracted from the receiver opening 17.

To fasten an evaporator flask in a secured manner to the vapor leadthrough of a rotary evaporator or to release it therefrom, the following procedure can therefore be carried out.

For the secured fastening, the end of the evaporator flask provided with a ground socket is introduced into the securing apparatus 10 through the receiver opening 17 into which the slider plate 13 projects in its holding position. The push button 25 does not necessarily have to be actuated for this purpose since the opening margin 30 of the slider plate 13 is at least provided with an inclined chamfer 35 shown in FIGS. 1 and 2 in the region of the holding section 31, said chamfer forming a run-on ramp for the flanged rim of the evaporator flask and automatically effecting a pushing away or pressing of the slider plate 13 into the release position, in which the slider plate 13 is at least partly retracted from the receiver opening 17, on the introduction of the evaporator flask. Once the flanged rim of the evaporator flask has been introduced beyond the passage opening 21 into the receiver opening 17, the slider plate 13 is automatically pressed back into the holding position due to the preloading effect of the spring elements such that the holding section 31 again projects into the receiver opening 17 and in so doing engages behind the flanged rim formed at the end of the evaporator flask. The evaporator flask is in so doing introduced so far into the securing apparatus 10 until the ground socket of the evaporator flask moves into a sealing and holding engagement with the ground cone of the vapor leadthrough. The evaporator flask is then secured in a shape-matched manner to the rotary drive.

To remove the evaporator flask from the rotary drive, the security is released in that the push button 25 is actuated and the slider plate 13 is thus displaced into its release position to release the receiver opening 17 for a removal. The end of the evaporator flask provided with the ground socket can then be pulled of the ground cone of the vapor leadthrough and the evaporator flask can be released from the rotary evaporator.

Since the slider plate 13 cannot only adopt the holding position shown in FIGS. 1 and 2, but also any other holding position located between the shown holding position and the release position, evaporator flasks of different constructions—specifically of different standard tapers—can be secured using the securing apparatus in accordance with the invention. In addition, the reliability of the securing connection is not impaired by any tolerances of the components forming the ground socket and the ground cone. It is a further advantage of the invention that the operation of the securing apparatus is particularly simple and intuitive.

### REFERENCE NUMERAL LIST

10 securing apparatus
11 fastening section
12 rear end
13 slider plate
14 internal thread
15 cover
16 front end
17 receiver opening
19 front ring surface
20 passage hole
21 passage opening
23 recess
25 push button
27 cut-out
29 runner
30 opening margin
31 holding section
33 elastomer insert
35 chamfer
37 elongate hole
39 narrow side
41 abutment
43 hollow
45 neck
51 guide recess
53 guide wall
55 blind hole
57A semi-round cut-out of the fastening section
57B semi-round cut-out of the cover
61 front end face
63 rear side of the cover
65 flat side
E introduction direction
V displacement direction
Z cylinder axis

1-20. (canceled)

21. A rotary evaporator having an apparatus for the securing of a ground joint between an evaporator flask and a vapor leadthrough, the ground joint comprising:
a ground socket; and
a ground cone,
the securing apparatus having:
a receiver opening for an end of the evaporator flask that is provided with the ground socket; and
a securing element that is adjustable between a holding position and a release position, the securing element having a holding section that projects into the receiver opening in the holding position and with the holding section being at least partly retracted from the receiver opening in the release position to selectively hold or release the end of the evaporator flask that is provided with the ground socket.

22. The rotary evaporator in accordance with claim 21,
wherein the securing element is supported in a plane extending transversely to an introduction direction of the ground socket and/or continuously displaceably.

23. The rotary evaporator in accordance with claim 21,
wherein the securing element is preloaded in the direction of the holding position.

24. The rotary evaporator in accordance with claim 21,
wherein the securing element has a run-on ramp that cooperates with the end of the evaporator flask provided with the ground socket on its introduction into the receiver opening to press the securing element out of its holding position into the release position.

25. The rotary evaporator in accordance with claim 21,
wherein the securing apparatus comprises an actuation element by means of which the securing element can be adjusted from the holding position into the release position.

26. The rotary evaporator in accordance with claim 25,
wherein the actuation element is formed in one part with the securing element.

27. The rotary evaporator in accordance with claim 21,
wherein the securing element is configured as a slider plate.

28. The rotary evaporator in accordance with claim 27,
wherein axes of the receiver opening and of the passage opening are offset in parallel with one another in the holding position and/or extend coaxially with one another in the release position.

29. The rotary evaporator in accordance with claim 27,
wherein the holding section is formed by a part of an opening margin of the securing element bounding the passage opening.

30. The rotary evaporator in accordance with claim 21,
wherein a respective spring element is provided at at least one narrow side of the securing element to preload the securing element in the direction of the holding position.

31. The rotary evaporator in accordance with claim 30,
wherein the respective spring element is, on the one hand, supported at a respective outwardly projecting abutment formed at the respective narrow side and is, on the other hand, supported at a respective counter bearing provided in the securing apparatus.

32. The rotary evaporator in accordance with claim 21,
wherein the securing element is supported by means of a sliding support in the securing apparatus.

33. The rotary evaporator in accordance with claim 21,
wherein the holding section has a recess in its region cooperating with the end of the evaporator flask provided with the ground socket.

34. The rotary evaporator in accordance with claim 21,
wherein the holding section is provided with a fixed-shape, elastically deformable plastic in its region cooperating with the end of the evaporator flask provided with the ground socket.

35. The rotary evaporator in accordance with claim 21,
wherein the securing apparatus comprises a fastening section having first and second ends, with the first end being fastened to a rotary drive of the rotary evaporator and the second end being provided with the receiver opening.

36. The rotary evaporator in accordance with claim 35,
wherein the first end of the fastening section is provided with a thread by means of which the fastening section is screwed onto a counter-thread formed at the rotary drive.

37. The rotary evaporator in accordance with claim 35,
wherein an annular cover is fastened to the other end of the fastening section and the receiver opening extends through said annular cover.

38. The rotary evaporator in accordance with claim 21,
wherein the securing element is arranged in a sliding seat.

39. The rotary evaporator in accordance with claim 38,
wherein the sliding seat is formed between a fastening section and an annular cover.

40. The rotary evaporator in accordance with claim 39,
wherein the securing element has at least one elongate hole through which a respective fastening means is led for fastening the cover to the fastening section.

41. The apparatus in accordance with claim 39,
the cover has at least one counter bearing for a respective spring element to preload the securing element in the direction of the holding position.

42. An apparatus for the securing of a ground joint between an evaporator flask and a vapor leadthrough, with the ground joint comprising:
a ground socket; and
a ground cone,
wherein the securing apparatus has a receiver opening for the end of the evaporator flask provided with the ground socket and has a securing element that is adjustable between a holding position and a release position, with the securing element having a holding section that projects into the receiver opening in the holding position and with the securing element being at least partly retracted from the receiver opening in the release position to selectively hold or release the end of the evaporator flask provided with the ground socket.
